(19) United States
(12) Patent Application Publication
(10) Pub. No.: US 2018/0003298 A1
(43) Pub. Date: Jan. 4, 2018

(54) BELT TYPE CONTINUOUSLY VARIABLE TRANSMISSION

(71) Applicant: Honda Motor Co.,Ltd., Tokyo (JP)

(72) Inventors: Toru YAGASAKI, Saitama (JP); Soichiro SUMIDA, Saitama (JP); Ryohta AOKI, Saitama (JP); Shigeru KANEHARA, Saitama (JP)

(73) Assignee: Honda Motor Co.,Ltd., Tokyo (JP)

(21) Appl. No.: 15/630,960

(22) Filed: Jun. 23, 2017

(30) Foreign Application Priority Data
Jul. 1, 2016 (JP) 2016-131495

(51) Int. Cl. F16H 61/662; F16H 55/56

(52) U.S. Cl. CPC F16H 61/66272; F16H 55/56; F16H 61/66259

(57) ABSTRACT

The present invention addresses problems of decrease in coefficient of friction and transmission efficiency, and increase in wear of a pulley and a metal element caused by a stopper regulating a moving end of a movable side pulley half of a belt type continuously variable transmission. In a belt type continuously variable transmission in which a metal belt is wound around a drive pulley and a driven pulley, in LOW change gear ratio, a movable side pulley half of the drive pulley is not confined in axial direction, and the movable side pulley half of the driven pulley abuts the closing stopper to regulate movement in closing direction, and in OD change gear ratio, the movable side pulley half of the drive pulley is not confined in the axial direction, and the movable side pulley half of the driven pulley abuts an opening stopper to regulate movement in opening direction.

### CROSS-REFERENCE TO RELATED APPLICATION

This application claims the priority benefit of Japan application serial no. 2016-131495, filed on Jul. 1, 2016. The entirety of the above-mentioned patent application is hereby incorporated by reference herein and made a part of this specification.

### BACKGROUND OF THE INVENTION

### Field of the Invention

The present invention relates to a belt type continuously variable transmission that includes a drive pulley including a movable side pulley half that is openable and closable in an axial direction with respect to a fixed side pulley half, a driven pulley including a movable side pulley half that is openable and closable in an axial direction with respect to the fixed side pulley half, and a metal belt that is wound around the drive pulley and the driven pulley, wherein a change gear ratio is changed between LOW and OD by changing groove widths of the drive pulley and the driven pulley with hydraulic pressure.

### Description of Related Art

A stopper that is provided to regulate a limit position in an opening direction of a movable side pulley half (a movable sheave) of a drive pulley (a primary pulley) of a belt type continuously variable transmission as in Patent Document 1 is known. In this manner, when a groove width of a pulley is fixed to a predetermined value by pressing the movable side pulley half against the stopper, it is possible to ensure accuracy of a LOW change gear ratio.

### PRIOR ART DOCUMENT

### Patent Documents

[Patent Document 1] Japanese Patent No. 5178602

### SUMMARY OF THE INVENTION

FIG. 5 is a schematic view of a belt type continuously variable transmission in which an endless metal belt 03 is wound around a drive pulley 01 and a driven pulley 02 viewed in an axial direction. The metal belt 03 includes a tight side string from an outlet of the drive pulley 01 toward an inlet of the driven pulley 02 and a loose side string from an outlet of the driven pulley 02 toward an inlet of the drive pulley 01. In the tight side string, metal elements 05 supported on a metal ring 04 come in close contact with each other, and a driving force is transmitted from the drive pulley 01 to the driven pulley 02 due to pressing force between the metal elements 05. On the other hand, in the loose side string, gaps are generated between the metal elements 05 so that no driving force is transmitted.

In an idle arc area on an inlet side of the drive pulley 01 that is continuous on a downstream side of the loose side string, gaps remain between the metal elements 05. However, in an active arc area that is positioned on a downstream side thereof and is continuous along the tight side string, the metal elements 05 come in close contact with each other. In the driven pulley 02, the entire area from the inlet to the outlet is the active arc area, and the metal elements 05 come in close contact with each other. Here, in the loose side string and the idle arc area in FIG. 5, gaps between the metal elements 05 are shown larger than they actually are.

Incidentally, as described in the Patent Document 1, when the movable side pulley half of the drive pulley is pressed against the stopper due to hydraulic pressure in order to ensure accuracy of a LOW change gear ratio, the following problems occur. That is, when the movable side pulley half of the drive pulley abuts the stopper in a LOW change gear ratio, a reaction force due to the abutment of the movable side pulley half and the stopper is superimposed on the pulley thrust (a force with which a metal belt is clamped between the fixed side pulley half and the movable side pulley half) due to hydraulic pressure. Therefore, it is necessary to change hydraulic pressure with which the movable side pulley half is biased in order to offset the reaction force.

In this case, as described above, since the drive pulley includes the active arc area and the idle arc area, due to a change in hydraulic pressure with which the movable side pulley half is biased, a pulley V surface of the fixed side pulley half and the movable side pulley half is elastically deformed, and sizes of the active arc area and the idle arc area are changed. Therefore, it is possible to increase a frictional force of the pulley V surface and prevent the metal belt from slipping, and it is possible to maintain surface pressure between the pulley V surface and the metal belt at a proper value and prevent the occurrence of abnormal wear. However, since the above control is influenced by rigidity of the pulley, there are problems in that it is difficult to ensure an active are area of an appropriate size according to a transmission torque at that time, and before and after the movable side pulley half abuts the stopper, a slip amount of the metal belt is changed, a coefficient of friction decreases, transmission efficiency decreases, and amounts of wear of the pulley and the metal element increase.

The present invention has been made in view of the above-described circumstances and is provided to address problems caused by the stopper that regulates a moving end of a movable side pulley half of a belt type continuously variable transmission.

In order to achieve the above object, an invention according to claim 1 proposes a belt type continuously variable transmission that includes a drive pulley including a movable side pulley half that is openable and closable in an axial direction with respect to a fixed side pulley half, a driven pulley including a movable side pulley half that is openable and closable in an axial direction with respect to the fixed side pulley half, and a metal belt that is wound around the drive pulley and the driven pulley, wherein a change gear ratio is changed between LOW and OD by changing groove widths of the drive pulley and the driven pulley with hydraulic pressure, and in the LOW change gear ratio, the movable side pulley half of the drive pulley is not confined in the axial direction, and the movable side pulley half of the driven pulley abuts a closing stopper to regulate movement in a closing direction, and in the OD change gear ratio, the movable side pulley half of the drive pulley is not confined in the axial direction, and the movable side pulley half of the driven pulley abuts an opening stopper to regulate movement in an opening direction.

According to claim 1, in the LOW change gear ratio, the movable side pulley half of the drive pulley is not confined in an axial direction, and the movable side pulley half of the driven pulley abuts a closing stopper to regulate movement in a closing direction. On the other hand, in the LOW change gear ratio, when the movable side pulley half of the drive pulley is confined in an axial direction by an opening stopper, it is necessary to change hydraulic pressure with which the movable side pulley half is biased in order to offset a reaction force received by the movable side pulley half from the opening stopper. Accordingly, there are problems in that, before and after the movable side pulley half abuts the opening stopper, a size of an active arc area of the drive pulley changes, a slip amount of the metal belt changes, a coefficient of friction decreases, a transmission efficiency decreases, and amounts of wear of the pulley and the metal element increase. However, in the present invention, since a closing stopper that confines the movable side pulley half of the driven pulley in an axial direction is provided on the driven pulley side that includes only an active arc area without an idle arc area in the LOW change gear ratio, no change occurs in the size of the active arc area of the driven pulley before and after the movable side pulley half abuts the closing stopper, and problems such as a decrease in coefficient of friction, a decrease in transmission efficiency, and an increase of amounts of wear of the pulley and the metal element are addressed.

In addition, according to claim 1, in the OD change gear ratio, the movable side pulley half of the drive pulley is not confined in the axial direction, and the movable side pulley half of the driven pulley abuts an opening stopper to regulate movement in an opening direction. On the other hand, in the OD change gear ratio, when the movable side pulley half of the drive pulley is confined by the closing stopper in the axial direction, it is necessary to change hydraulic pressure with which the movable side pulley half is biased in order to offset a reaction force received by the movable side pulley half from the closing stopper, and there are problems in that, before and after the movable side pulley half abuts the closing stopper, a size of the active arc area of the drive pulley changes, a slip amount of the metal belt changes, a coefficient of friction decreases, a transmission efficiency decreases, and amounts of wear of the pulley and the metal element increase. However, in the present invention, since an opening stopper that confines the movable side pulley half of the driven pulley in the axial direction is provided on the driven pulley side that includes only an active arc area without an idle arc area in the OD change gear ratio, no change occurs in the size of the active arc area of the driven pulley before and after the movable side pulley half abuts the opening stopper, and problems such as a decrease in coefficient of friction, a decrease in transmission efficiency, and an increase of amounts of wear of the pulley and the metal element are addressed.

### BRIEF DESCRIPTION OF THE DRAWINGS

FIG. 1 is a diagram showing a structure of a belt type continuously variable transmission.

FIG. 2(A) and FIG. 2(B) shows graphs of a relationship between coefficients of friction of a pulley and a metal belt with respect to an input torque.

FIG. 3(A) and FIG. 3(B) shows graphs of a relationship between transmission efficiencies of driving forces with respect to an input torque.

FIG. 4 shows a graph of wear depths of pulleys after a durability test in a LOW change gear ratio.

FIG. 5 is an explanatory diagram showing active arc areas and idle arc areas of a pulley.

### DESCRIPTION OF THE EMBODIMENTS

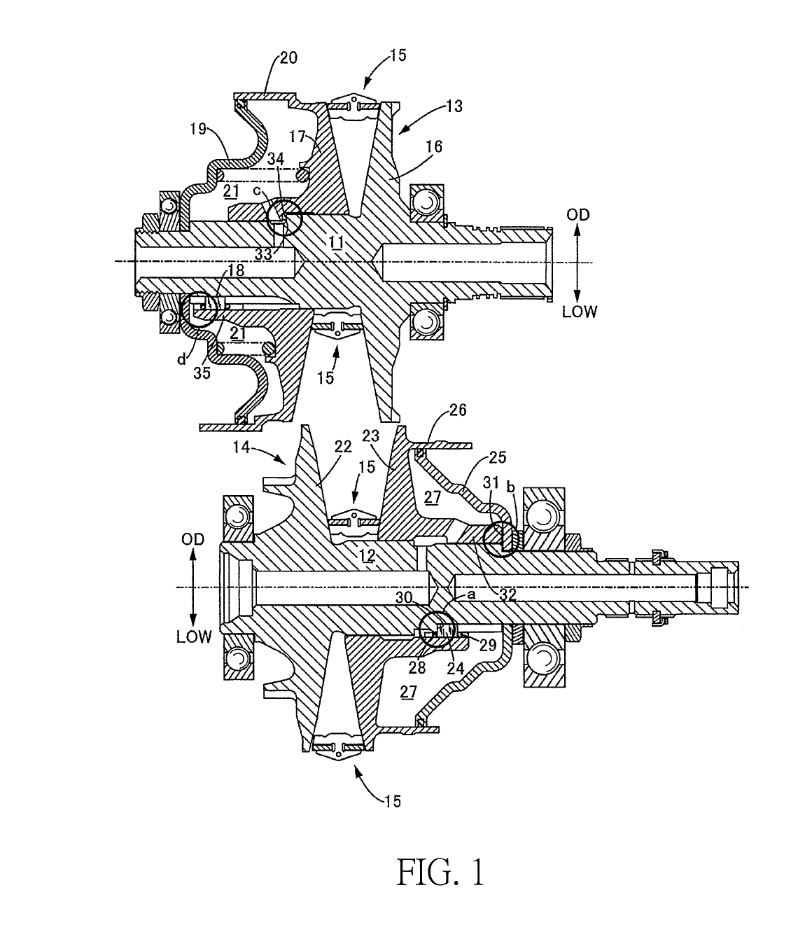

Embodiments of the present invention will be described below with reference to FIG. 1 to FIG. 4.

As shown in FIG. 1, a belt type continuously variable transmission transmits rotation of an input shaft 11 connected to an engine to an output shaft 12 connected to a drive wheel in a continuously variable transmission manner, and includes a metal belt 15 that is wound around a drive pulley 13 provided on the input shaft 11 and a driven pulley 14 provided on the output shaft 12. Here, in FIG. 1, the upper side of axes of the input shaft 11 and the output shaft 12 shows an overdrive (OD) state in which the change gear ratio becomes minimum and the lower side of axes of the input shaft 11 and the output shaft 12 shows a low (LOW) state in which the change gear ratio becomes maximum.

The drive pulley 13 includes a fixed side pulley half 16 fixed to the input shaft 11 and a movable side pulley half 17 that is axially slidable and relatively non-rotatably supported on the input shaft 11 through a sliding key 18. The movable side pulley half 17 can approach or move away from the fixed side pulley half 16. A piston 19 fixed to the input shaft 11 is slidably fitted to a cylinder 20 that is integrally formed with the movable side pulley half 17. An oil chamber 21 is formed by the piston 19, the cylinder 20 and the movable side pulley half 17.

The driven pulley 14 includes a fixed side pulley half 22 fixed to the output shaft 12 and a movable side pulley half 23 that is axially slidable and relatively non-rotatably supported on the output shaft 12 through a sliding key 24. The movable side pulley half 23 can approach or move away from the fixed side pulley half 22. A piston 25 fixed to the output shaft 12 is slidably fitted to a cylinder 26 that is integrally formed with the movable side pulley half 23. An oil chamber 27 is formed by the piston 25, the cylinder 26, and the movable side pulley half 23.

Therefore, when hydraulic pressure applied to the oil chamber 21 of the drive pulley 13 is reduced to increase hydraulic pressure applied to the oil chamber 27 of the driven pulley 14, the movable side pulley half 17 of the drive pulley 13 moves away from the fixed side pulley half 16, a groove width increases, the movable side pulley half 23 of the driven pulley 14 approaches the fixed side pulley half 22, a groove width decreases, a winding diameter of the metal belt 15 with respect to the drive pulley 13 decreases, and a winding diameter of the metal belt 15 with respect to the driven pulley 14 increases. Accordingly, the change gear ratio increases toward LOW.

On the other hand, when hydraulic pressure applied to the oil chamber 21 of the drive pulley 13 is increased to reduce hydraulic pressure applied to the oil chamber 27 of the driven pulley 14, the movable side pulley half 17 of the drive pulley 13 approaches the fixed side pulley half 16, a groove width decreases, the fixed side pulley half 22 moves away from the movable side pulley half 23 of the driven pulley 14, a groove width increases, a winding diameter of the metal belt 15 with respect to the drive pulley 13 increases, and a winding diameter of the metal belt 15 with respect to the driven pulley 14 decreases. Accordingly, the change gear ratio decreases toward OD.

In the movable side pulley half 23 of the driven pulley 14, the sliding key 24 is fixed to a pair of clips 28 and 29. When the movable side pulley half 23 approaches the fixed side pulley half 22 and reaches a LOW change gear ratio, the left end of the sliding key 24 in the drawing can abut a closing stopper 30 formed of a step provided on the output shaft 12 (refer to part a in FIG. 1). In addition, when the movable side pulley half 23 moves away from the fixed side pulley half 22 and reaches an OD change gear ratio, the right end of a cylindrical boss part 32 in the drawing that slidably supports the movable side pulley half 23 on the output shaft 12 can abut an opening stopper 31 formed of a base of the piston 25 fixed to the output shaft 12 (refer to part b in FIG. 1).

When the change gear ratio changes toward OD, the movable side pulley half 17 of the drive pulley 13 approaches the fixed side pulley half 16. However, even if the change gear ratio reaches OD, a step 33 of the movable side pulley half 17 does not abut a step 34 of the input shaft 11 (refer to part c in the drawing), and movement of the movable side pulley half 17 is not regulated. In addition, when the change gear ratio changes toward LOW, the movable side pulley half 17 of the drive pulley 13 moves away from the fixed side pulley half 16. However, even if the change gear ratio reaches LOW, the left end of a boss part 35 of the movable side pulley half 17 in the drawing does not abut a base of the piston 19 fixed to the input shaft 11 (refer to part d in the drawing), and movement of the movable side pulley half 17 is not regulated.

Next, the operation of an embodiment of the present invention having the above configuration will be described.

In FIG. 1, when hydraulic pressure applied to the oil chamber 21 of the drive pulley 13 is reduced to increase hydraulic pressure applied to the oil chamber 27 of the driven pulley 14, the movable side pulley half 17 of the drive pulley 13 moves away from the fixed side pulley half 16, a groove width increases, the movable side pulley half 23 of the driven pulley 14 approaches the fixed side pulley half 22, and a groove width decreases. Accordingly, the change gear ratio changes toward LOW. The sliding key 24 provided on the movable side pulley half 23 of the driven pulley 14 abuts the closing stopper 30 and the change gear ratio is fixed at LOW.

In this manner, in the present embodiment, the LOW change gear ratio is established by the closing stopper 30 provided on the driven pulley 14 side. On the other hand, as a comparative example, a case in which movement of the movable side pulley half 17 to the opening side is regulated by the opening stopper provided on the drive pulley 13 side and the LOW change gear ratio is established is considered.

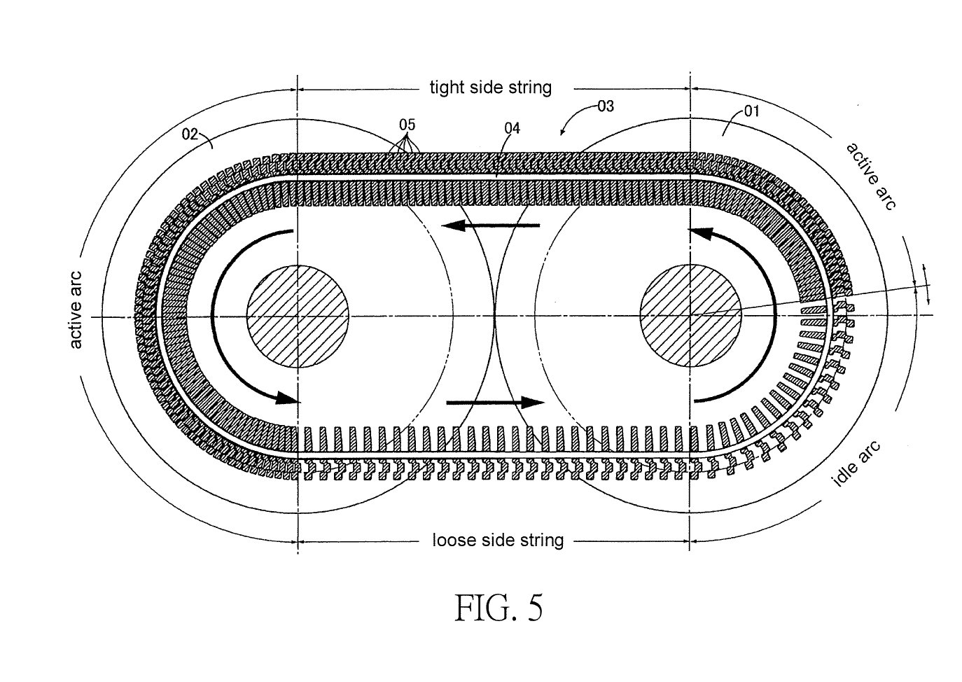

In the comparative example, when the change gear ratio reaches LOW and the movable side pulley half 17 of the drive pulley 13 is pressed against the opening stopper by pulley thrust due to hydraulic pressure, since the pulley thrust due to the hydraulic pressure is biased by a reaction force due to abutment of the movable side pulley half 17 and the opening stopper, it is necessary to reduce the pulley thrust due to the hydraulic pressure in order to prevent wear of the metal belt 15 and the pulley V surface. As shown in FIG. 5, the drive pulley 13 includes active arc areas and idle arc areas, the fixed side pulley half 16 and the movable side pulley half 17 of the drive pulley 13 are locally elastically deformed due to a decrease in pulley thrust due to hydraulic pressure, and the active arc areas are reduced and the idle arc areas enlarged. Therefore, a frictional force of the pulley V surface is reduced and the occurrence of abnormal wear is prevented.

However, since amounts of change in the active arc areas and the idle arc areas are influenced by rigidity of the pulley, there are problems in that it is difficult to ensure an active arc area of an appropriate size according to a transmission torque at that time, and before and after the movable side pulley half 17 abuts the opening stopper, a slip amount of the metal belt 15 changes, a coefficient of friction decreases, a transmission efficiency decreases, and amounts of wear of the pulley and the metal element increase (refer to the upper rows in Table 1).

TABLE 1

| | | | | Coefficient | Transmission | Favorable or |
|---|---|---|---|---|---|---|
| | | DR | DN | of friction | efficiency | unfavorable |
| Comparative | LOW | Opening stopper | FREE | Low | Low | Unfavorable |
| Example | OD | Closing stopper | FREE | Slightly low | Slightly low | Unfavorable |
| Present | LOW | FREE | Closing stopper | High | High | Favorable |
| invention | OD | FREE | Opening stopper | Slightly high | Slightly high | Favorable |

On the other hand, in the present embodiment in which the closing stopper 30 of the movable side pulley half 23 is provided on the driven pulley 14 side, while the change gear ratio changes toward LOW, even if the movable side pulley half 23 abuts the closing stopper 30, a reaction force load for preventing an increase in pulley thrust is generated, hydraulic pressure applied to the oil chamber 27 of the driven pulley 14 is increased to offset the reaction force load, and since only an active arc area is provided in the driven pulley 14 in the first place, the ratio between the active arc area and the idle arc area is not changed. As a result, before and after the movable side pulley half 23 abuts the closing stopper 30, a sudden change in slip amount of the metal belt 15 is avoided, and a decrease in coefficient of friction, a decrease in transmission efficiency, and an increase in amounts of wear of the pulley and the metal element are reduced (refer to the lower rows in Table 1).

In addition, in the present embodiment, the OD change gear ratio is established by the opening stopper 31 provided on the driven pulley 14 side. On the other hand, a comparative example in which movement of the movable side pulley half 17 to the closing side is regulated by a closing stopper provided on the drive pulley 13 side and the OD change gear ratio is established is considered.

In the comparative example, when the change gear ratio reaches OD and the movable side pulley half 17 of the drive pulley 13 is pressed against the closing stopper by pulley thrust due to hydraulic pressure, since the pulley thrust due to the hydraulic pressure is offset by the reaction force due to abutment of the movable side pulley half 17 and the closing stopper, it is necessary to increase the pulley thrust due to the hydraulic pressure in order to prevent the metal belt 15 from slipping. However, since the pulley V surface of the fixed side pulley half 16 and the movable side pulley half 17 of the drive pulley 13 is elastically deformed due to an increase in the pulley thrust, the active arc areas enlarged, and the idle arc areas are reduced, there are problems in that, before and after the movable side pulley half 17 abuts the closing stopper, a slip amount of the metal belt 15 changes, a coefficient of friction decreases, a transmission efficiency decreases, and amounts of wear of the pulley and the metal element increase (refer to the upper rows in Table 1).

On the other hand, in the present embodiment in which the opening stopper 31 of the movable side pulley half 23 is provided on the driven pulley 14 side, while the change gear ratio changes toward OD, the movable side pulley half 23 abuts the opening stopper 31 and a reaction force load is generated, and even if hydraulic pressure applied to the oil chamber 27 of the driven pulley 14 is reduced to offset the reaction force load, since only an active arc area is provided in the driven pulley 14 in the first place, the ratio between the active arc area and the idle arc area is not changed. As a result, a change in ratio between the active arc area and the idle arc area according to abutment of the movable side pulley half 23 and the opening stopper 31 is avoided, and a decrease in coefficient of friction, a decrease in transmission efficiency, and an increase in amounts of wear of the pulley and the metal element are reduced (refer to the lower rows in Table 1).

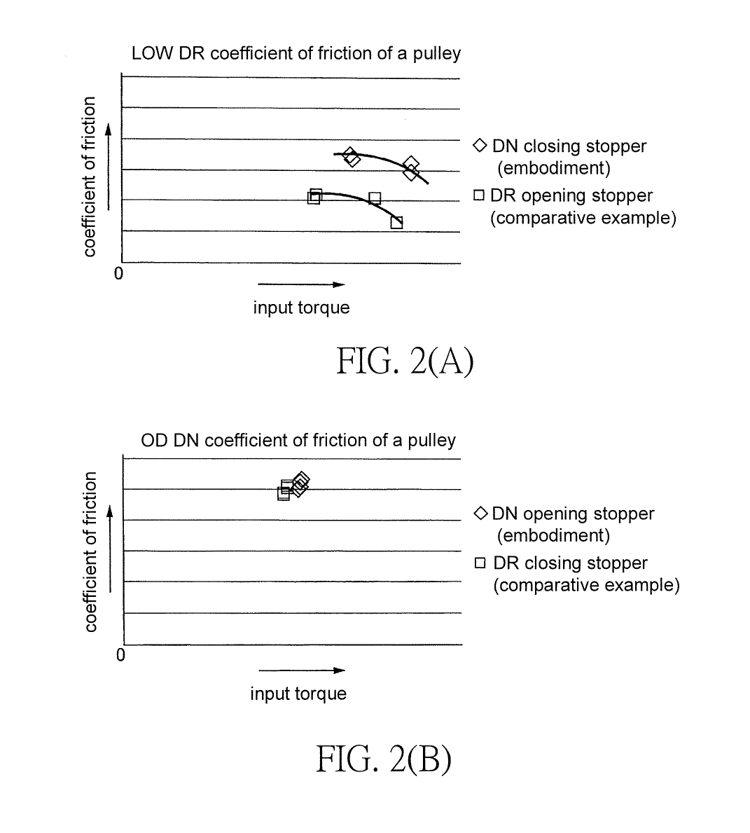

Graphs in FIG. 2 show coefficients of friction between the metal belt 15 and the pulley with respect to an input torque of the belt type continuously variable transmission. FIG. 2A shows the case of a LOW change gear ratio and it can be understood that the coefficient of friction in the embodiment (refer to ⋄) in which the closing stopper 30 is provided on the driven pulley 14 side exceeds that of the comparative example (refer to □) in which the opening stopper is provided on the drive pulley 13 side. In addition, FIG. 2B shows the case of an OD change gear ratio, and it can be understood that the coefficient of friction in the embodiment (refer to ⋄) in which the opening stopper 31 is provided on the driven pulley 14 side is slightly higher than that of the comparative example (refer to □) in which the closing stopper is provided on the drive pulley 13 side.

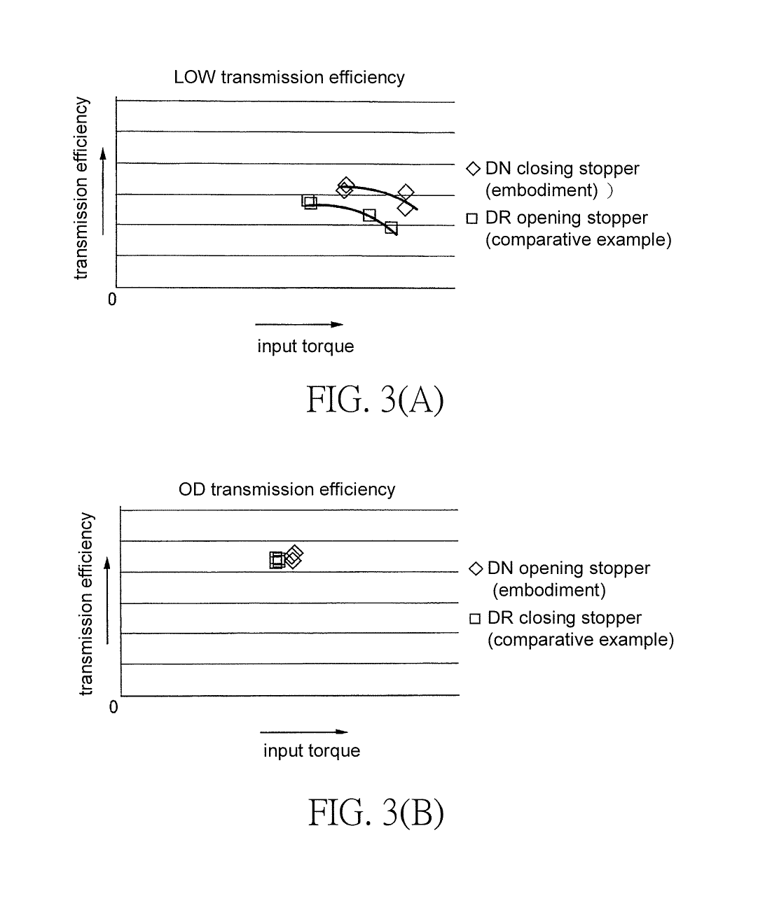

Graphs in FIG. 3 show transmission efficiencies of driving forces of the belt type continuously variable transmission with respect to an input torque of the belt type continuously variable transmission. FIG. 3A shows the case of a LOW change gear ratio and it can be understood that the transmission efficiency in the embodiment (refer to ⋄) in which the closing stopper 30 is provided on the driven pulley 14 side exceeds that of the comparative example (refer to □) in which the opening stopper is provided on the drive pulley 13 side. In addition, FIG. 3B shows the case of an OD change gear ratio and it can be understood that the transmission efficiency in the embodiment (refer to ⋄) in which the opening stopper 31 is provided on the driven pulley 14 side is slightly higher than that of the comparative example (refer to □) in which the closing stopper is provided on the drive pulley 13 side.

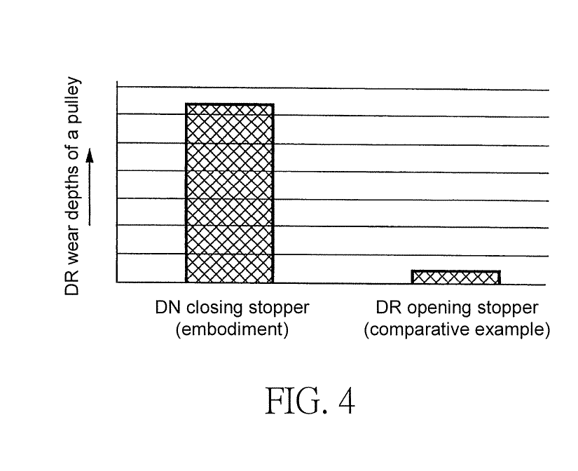

A graph in FIG. 4 shows wear depths of the drive pulley 13 generated in a durability test performed in a LOW change gear ratio, and it can be understood that the amount of wear in the embodiment is significantly smaller than the amount of wear in the comparative example.

While the embodiment of the present invention has been described above, various design modifications can be made without departing from the scope of the present invention.

For example, specific structures of the closing stopper 30 and the opening stopper 31 are not limited to the embodiment.

What is claimed is:

1. A belt type continuously variable transmission comprising:
a drive pulley (13) including a movable side pulley half (17) that is openable and closable in an axial direction with respect to a fixed side pulley half (16);
a driven pulley (14) including a movable side pulley half (23) that is openable and closable in an axial direction with respect to a fixed side pulley half (22); and
a metal belt (15) that is wound around the drive pulley (13) and the driven pulley (14),
wherein a change gear ratio is changed between LOW and OD by changing groove widths of the drive pulley (13) and the driven pulley (14) with hydraulic pressure, and
wherein, in the LOW change gear ratio, the movable side pulley half (17) of the drive pulley (13) is not confined in the axial direction, and the movable side pulley half (23) of the driven pulley (14) abuts a closing stopper (30) to regulate movement in a closing direction, and
in the OD change gear ratio, the movable side pulley half (17) of the drive pulley (13) is not confined in the axial direction, and the movable side pulley half (23) of the driven pulley (14) abuts an opening stopper (31) to regulate movement in an opening direction.
